(19) United States
(12) Patent Application Publication
(10) Pub. No.: US 2023/0003676 A1
(43) Pub. Date: Jan. 5, 2023

(54) GRAPHENE-BASED GAS SENSING PLATFORM

(71) Applicant: The Penn State Research Foundation, University Park, PA (US)

(72) Inventors: Huanyu Cheng, State College, PA (US); Ning Yi, State College, PA (US)

(21) Appl. No.: 17/783,393

(22) PCT Filed: Dec. 11, 2020
(86) PCT No.: PCT/US2020/064501

§ 371 Date: Jun. 8, 2022

Related U.S. Application Data
(60) Provisional application No. 62/946,547, filed on Dec. 11, 2019.

(51) Int. Cl. G01N 27/12

(52) U.S. Cl. CPC G01N 27/127

(57) ABSTRACT

A gas sensing platform for sensing a gas component includes a chemoresistive gas sensor and a supporting substrate. The sensor includes a sensing region made of porous graphene having two interconnect regions each extending continuously from the sensing region and a gas-sensitive nanomaterial dispersed in the sensing region operable to deconvolute the gas component from a gas mixture. The chemoresistive gas sensor responds to the gas component by changing the resistance of the gas sensing region as the gas-sensitive nanomaterial binds with the gas component.

### CROSS REFERENCE TO RELATED APPLICATION

This application is the U.S. National Stage of PCT/US2020/064501 filed on Dec. 11, 2020, which claims priority from U.S. Provisional Patent Application Ser. No. 62/946,547, filed Dec. 11, 2019, the entire content of both are incorporated herein by reference in their entirety.

### FIELD OF THE INVENTION

This invention relates to a gas sensing platform, in particular, a highly sensitive porous graphene-based gas sensing platform which may be stretchable and have self-heating capabilities.

### BACKGROUND OF THE INVENTION

The recent development of wearable electronics has drawn considerable attention from both academia and industry. Because wearable electronic devices can conform to and follow the deformation of the skin, they are capable of capturing various essential mechanical, thermal, chemical, electrical, and biological signals, demonstrating an excellent potential for future healthcare monitoring applications. Though continuous recording and analysis of gaseous compounds bear significant importance in healthcare, the study of wearable gas sensors for toxic gas detection, environmental air quality monitoring, and breath analysis has only commenced recently. As one representative example, nitrogen dioxide (NO₂) is one of the most prominent toxic air pollutants from the combustion of fossil fuel. Inhaling at low concentration can cause symptoms such as asthma, bronchitis, and emphysema. Long-term exposure can lead to heart failure and dysrhythmia. Therefore, there is an increasing demand for the development of wearable gas sensors to provide accurate and continuous recording of NO₂. Wearable gas sensors can also enable the direct monitoring of the odours released from the human body to help inform the health conditions. Compared to their industrial counterparts, the development of wearable gas sensors needs to address additional challenging requirements, including lightweight and small form factor, low operating temperature, low energy consumption, and mechanical robustness upon various skin deformations.

### SUMMARY OF THE INVENTION

The present invention provides embodiments of a graphene-based gas sensing platform for sensing a gas component. The gas sensing platform includes a chemoresistive gas sensor and a supporting substrate. The chemoresistive gas sensor includes a sensing region made of porous graphene having two interconnect regions each extending continuously from the sensing region.

In an embodiment, the gas-sensitive nanomaterial may be dispersed in the sensing region for an increased sensitivity of deconvoluting the gas component from a gas mixture. The chemoresistive gas sensor responds to the gas component by changing the resistance of the gas sensing region as the gas-sensitive nanomaterial binds with the gas component. The response is characterized by a ratio (R₀−R)/R₀, where R₀ is a resistance of the sensing region in the presence of only air and R is the resistance of the sensing region in the presence of the gas to be detected. The magnitude of the response measures the concentration.

In some embodiments, the interconnect regions are comprised of porous graphene and the interconnect regions are integrated with the sensing region. The interconnect regions may further comprise a layer of metal surface coating on the porous graphene for modulating the interconnect resistance of the interconnect region. Alternatively, the interconnect region may be made from any other conductive material.

The gas-sensitive nanomaterial may be selected from, but not limited to, rGO, MoS₂, rGO/MoS₂, ZnO/CuO core/shell nanomaterials, carbon nanotubes, one dimensional nanostructured metal-oxides, graphene/metal oxide hybrid.

The substrate may be rigid, flexible or stretchable depending on the applications of the sensing platform. A stretchable substrate may be used for a sensor applied on human skin.

In some embodiments, the interconnect regions may be configured to have an interconnect resistance smaller than a sensing resistance of the sensing region, such that the sensing region generates localized heating upon an externally applied voltage due to the difference between the sensing resistance of the sensing region and the interconnect resistance of the interconnect regions. The larger the difference is, the better. The ratio of the sensing resistance to the interconnect resistance can be tuned by changing the geometrical parameters (width, length and thickness) of the sensing region and the interconnect region. The interconnect regions may also be coated with a metal layer to obviate the need for a significantly reduced linewidth and increased length in the sensing region. As the metal coating significantly reduces the resistance in the interconnect regions to result in localized heating in the sensing region, the power consumption may be minimized.

It is desired for the porous graphene to have a 3D foam structure. In some embodiments, the porous graphene is laser-induced graphene.

The sensing region may be a straight line or a non-linear shape. The interconnect regions may be straight or wavy or serpentine or any other nonlinear shape. For a biomedical application with a stretchable substrate, a non-linear shape such as serpentine is preferred.

A gas sensing platform array can be formed comprising an array of the gas sensing platforms according to any embodiment of the present invention, where the sensing region of each gas sensing platform is decorated with a different nanomaterial such that each gas sensing platform in the array is tailored to a different gas component.

The present invention also provides embodiments of a method of making a gas sensing platform for sensing a gas component with an ultralow concentration. The method may include the steps of forming porous graphene patterns on a film of carbon source material using a laser system. The pattern may include a sensing region disposed between two interconnect regions each extending continuously from ends of the sensing region. The pattern may then be cut off using the laser system and transferred onto a rigid, flexible or stretchable substrate. A metal layer may be coated onto the interconnect regions and gas-sensitive nanomaterials may be deposited in the sensing region for binding to the gas component.

The carbon source may be polyimide films, modified polyimide and phenolic resin, lignocellulose materials, polyetherimide (PEI), sulfonated poly(ether ether ketone), polysulfone, polyethersulfone, and naturally occurring wood.

While cutting off the pattern, a small area of the original film around the sensing region may be cut off as well to reduce strain interference.

Using a sensing platform in accordance with an embodiment of the present invention, at a proper self-heating condition, the nanomaterial/LIG gas sensor exhibits fast response/recovery and ultrasensitive detection of gas such as NO₂, with a limit of detection of approximately 1.5 parts per billion (ppb) at low power consumption and in an ambient temperature.

It is an advantage of embodiments of the gas sensing platform in the present invention to be capable of detecting various gas components in ultralow concentrations. However, the present gas sensing platform can also be used to sense gases at much higher concentrations.

### BRIEF DESCRIPTION OF THE DRAWINGS

FIG. 1A is a schematic illustration of an exemplary fabrication process of preparing a stretchable LIG gas sensing platform in accordance with an embodiment of the present invention;

FIG. 1B is optical images of the LIG gas sensing platform and its demonstration to follow various deformations applied to it;

FIGS. 2A and 2B are optical images of the gas sensor bent over a cylinder and attached to the back surface of the hand respectively;

FIGS. 3A-3F are plots characterizing the LIG gas sensing platform;

FIGS. 4A-4D are XPS survey scans;

FIGS. 5A-5C are plots characterizing the LIG electrode with self-heating capabilities;

FIGS. 6A-6B are illustrations showing dependence of the resistance of the LIG electrode on its length and width respectively;

FIGS. 7A-7D are plots showing effects of the width and operating temperature from self-heating on the gas sensing performance;

FIG. 8 is a plot showing dependence of the temperature in the LIG electrode from self-heating on the input power;

FIGS. 9A-9F are plots showing the dynamic response, limit of detection, selectivity, and mechanical robustness of the gas sensor;

FIGS. 10A-10C are plots showing the gas sensing performance of pristine LIG lines to NO₂ of 1 ppm at 20° C.;

FIG. 11 is a plot showing the response of the MoS₂-LIG gas sensor to NO₂ of 1 ppm at 20° C.;

FIGS. 12A-12C are plots showing a comparison of the gas sensing performance between gas sensors with the big and small petal structures at (a) 20° C., (b) 40° C., and (c) 80° C. from self-heating, respectively;

FIG. 13 is a plot showing a comparison of the gas sensing performance for the LIG with the small petal structure between 20° C. and 80° C. with complete recovery time;

FIGS. 14A-14B are plots showing a comparison of the angle of the plateau calculated from response curves of gas sensors with the big and small petal structures at 20° C., 40° C., 60° C., and 80° C. from self-heating respectively;

FIG. 15 is a graph showing a comparison of the SNR between gas sensors with the big and small petal structures at different temperatures from self-heating;

FIG. 16 is a plot showing a dynamic response test of the gas sensors with the big and small petal structures in the presence of NO₂ from 200 ppb to 600 ppb;

FIG. 17 is a graph showing the effect of the high relative humidity (RH) of 88% on the response of the rGO/MoS₂-LIG gas sensor at different temperatures;

FIG. 18A is optical images of the setup for tensile test (upper) and three different PI patterns (lower);

FIG. 18B is a plot showing the averaged electrical resistance variation for different PI substrate designs under 20% tensile strain on both parallel and perpendicular directions with respect to the LIG single line;

FIGS. 18C-18D are plots showing the resistance variation curves of LIG gas sensing device with (c) 20% tensile strain in the parallel direction and (d) 20% tensile strain in the perpendicular direction, respectively;

FIG. 19 is a STEM image (HAADF) of Cu₂(nbdc)₂(dabco)-on-Zn₂(nbdc)₂(dabco) metal-organic framework (MOF) with accompanying EDS spectrum images to show the elemental distribution;

FIG. 20A is a plot showing the response of the ZnO/CuO-LIG gas sensor, in which ZnO/CuO core/shell nanomaterials were dispersed on LIG; and

FIG. 20B is a graph showing the selectivity of the ZnO/CuO-LIG gas sensor, in which ZnO/CuO core/shell nanomaterials were dispersed on LIG.

### DETAILED DESCRIPTION OF THE DRAWINGS

The present invention provides various embodiments of a graphene-based gas sensing platform, leveraging porous nanostructures of graphene, its good mechanical strength, electrical conductivity and thermal conductivity. The graphene-based gas sensing platform may include a sensing region comprised of a porous graphene platform. The porous graphene is coated with highly sensitive materials such as MoS₂, rGO/MoS₂.

The effective use of nanomaterials, because of their significantly increased surface to volume ratios and the formation of the p-n junction between p-type porous graphene and n-type gas-sensitive nanomaterials, leads to enhanced sensitivity, selectivity, and signal-to-noise ratio for the detection of a target gas component at an ultralow concentration.

For example, introducing n-type MoS₂ nanomaterials on the porous graphene could form p-n junctions to enhance the sensing performance. In the rGO/MoS₂ nanoflowers, while the p-type rGO sheets provide the overall conductivity, the n-type MoS₂ on the rGO sheets has multiple active sites with selective affinity to NO₂ gas molecules for sensing. The carrier concentration on the LIG changes upon NO₂ adsorption making the porous graphene-based platform an outstanding candidate for sensing NO₂.

The graphene can be highly porous laser-induced graphene (LIG). The laser used may be continuous-wave lasers such as CO₂ lasers, optically pumped solid state lasers, ultraviolet lasers, or pulsed lasers such as femtosecond lasers. Graphene may also be induced with focused irradiation, or other types of energy comparable to the lasers used. Any known or yet to be developed approach may be used to form the porous graphene.

The laser scribing parameters change the sheet resistance of the laser-induced graphene. The additional change in the linewidth and length of the LIG sensing region further provides ways to tune the resistance of the LIG sensing region. Given the same laser scribing parameters, the resistance of the LIG sensing region is found to be proportional to its length.

In an example, the time for a peak temperature of the LIG platform to reach equilibrium for an applied voltage in the range from 0.5 V to 12 V may be less than 20 s. The temperature of the gas sensing region can be controlled to be below 100° C.

In an example, the sensor has only a graphene sensing region and a graphene interconnect region extending continuously from both ends of the sensing region. The sensor may be placed on a supporting substrate. The substrate may be rigid, flexible or stretchable. There are no additional electrodes in the interconnect region and other sensing materials in the sensing region. In this example, the porous graphene itself supported by a substrate makes up a complete sensing platform due to its relatively high electrical conductivity and its large surface to volume ratio. The porous graphene sensing region may be a straight or nonlinear elongated region. The interconnect region may be a straight or nonlinear elongated region.

Some gas sensors in prior art use electrodes, such as interdigitated electrodes, that are separated by a small gap. As such, they form an open circuit until gas-sensing nanomaterials are deposited on the sensor to span this gap. The gas-sensing nanomaterials form the electrical path between the electrodes. In examples of the porous graphene gas sensing platform of the present invention, the graphene in the sensing region is continuous between the electrodes and therefore forms an electrical connection prior to the addition of gas-sensing nanomaterials.

In another example, the gas sensing platform has only a graphene sensing region and interconnect regions extending continuously from both ends of the sensing region. The interconnect regions may be made from conductive materials other than graphene. The sensor may be placed on a supporting substrate. There are no additional electrodes and other sensing materials in this example.

In another example, the gas sensing platform has only a graphene sensing region and graphene interconnect regions extending continuously from both ends of the sensing region. A layer of conductive material may be coated on the interconnect regions. The gas sensing platform may be placed on a supporting substrate. There are no additional electrodes and other sensing materials in this example.

In yet another example, the gas sensing platform has only a graphene sensing region and graphene interconnect regions extending continuously from both ends of the sensing region. Depending on the type of gas to be detected, a nanomaterial is selected to be disposed on the graphene sensing region. There are no additional electrodes needed. When the graphene sensing region is decorated with the nanomaterial, the response of the gas sensor is mainly contributed by the nanomaterial. There may be both chemical and physical bonds formed between the graphene and the nanomaterial.

In another example, the gas sensing platform has only a graphene sensing region and interconnect regions extending continuously from both ends of the sensing region. The interconnect regions may be made from conductive materials other than graphene. Depending on the type of gas to be detected, a nanomaterial is selected to be disposed on the graphene sensing region. There are no additional electrodes needed in this example.

In another example, the gas sensing platform has only a graphene sensing region and graphene interconnect regions extending continuously from both ends of the sensing region. The graphene sensing region and the graphene interconnect region may have different geometrical parameters such that the sensing region has a resistance much larger than the resistance of the interconnect region. As a result of this configuration, a localized self-heating effect will occur in the sensing region upon an externally applied voltage. There are no external or additional heaters needed for this example.

In yet another example, the gas sensing platform has only a graphene sensing region and graphene interconnect regions extending continuously from both ends of the sensing region. The interconnect region may be coated with a conductive material layer such that the sensing region has a resistance much larger than the resistance of the interconnect region. As a result, a localized self-heating effect will occur in the sensing region upon an externally applied voltage. There are no external or additional heaters needed for this example.

In a further example, the gas sensing platform has only a graphene sensing region and interconnect regions extending therefrom, with gas-sensitive nanomaterials decorating the sensing region. The interconnect regions may be of any conductive material with a resistance lower than the sensing region. In this example, a localized self-heating effect will occur in the sensing region upon an externally applied voltage. There are no external or additional heaters needed for this example.

In the above examples, which are limited to specific elements necessary for gas-sensing and/or self-heating, other elements may be provided in support of the gas-sensing platform, such as a supporting substrate, a thermal isolation layer, additional electrical leads connecting the interconnect regions to external measurement circuitry or equipment, and the external circuitry or equipment. Examples of the present invention that are limited to consisting of just the elements described above may include these supporting elements while still being considered to “consist of” just the elements mentioned.

The graphene has a porous 3D foam-like structure. The graphene may be laser-induced or induced with other means such as any focused irradiation.

In a preferred embodiment, the interconnect region may be coated with a layer of conductive material to increase the conductivity of the interconnect region and increase the contact surface. The design of having the sensing region and the interconnect region as an integral piece provides a mechanically and electrically robust gas sensor. The fabrication process is also made simple.

Alternatively, the interconnect region may be made from conductive materials different from the porous graphene. In that case, the electrical and mechanical connections between the sensing region and the interconnect region may not be as durable and stable. The fabrication process involved will be more complicated.

In a preferred embodiment, the porous graphene sensing region may be enhanced with gas-sensitive nanomaterials for sensing gas such as NO₂ at ultralow concentrations. Considering the vast difference in response between sensors with and without the highly sensitive nanomaterials, the response of the gas sensor is mainly contributed by the nanomaterials.

Various gas-sensitive nanomaterials may be selected from MoS₂, rGO/MoS₂, or ZnO/CuO core/shell nanomaterials, carbon nanotubes, one dimensional nanostructured metal-oxides, graphene/metal oxide hybrid, or any other known or yet to be developed gas-sensitive material capable of use in this invention.

In a preferred embodiment, the electrical conductivity of the interconnect region is significantly higher than the electrical conductivity of the sensing region. This difference between the electrical resistance of the interconnect region R_{interconenct} and the electrical resistance of the sensing region R_{sensing} can be achieved by the geometrical parameters and/or the location-dependent conductivity. For an example, the linewidth to length ratio of the sensing region and the interconnect region can be tuned to control the respective resistances. A smaller linewidth and a longer length in the sensing region increase its resistance relative to the interconnect region. For another example, a layer of metal can be coated on the graphene interconnect region to drastically reduces its resistance, obviating the need for a significantly reduced linewidth and increased length in the graphene sensing region. The metal coating can be of any conductive material, including Ag, Ni, Cu, etc.

In some examples, the sensing platform has a localized self-heating effect. The localized self-heating effect of the graphene-based gas sensing platform hinges on its location-dependent conductivity. A strong localized self-heating effect requires the resistance of the sensing region R_{sensing} to be significantly larger than that of the interconnect region R_{interconnect}.

The total resistance Rₜₒₜₐₗ of the gas sensing platform consists of the electrical resistance R_{graphene} in the graphene of the sensing region, R_{interconnect} in the interconnect region, and the contact resistance R_{contact} between nanomaterials (e.g., rGO/MoS₂) and graphene. The electrical resistance R_{sensing} in the sensing region may be a parallel connection of R_{graphene} and R_{contact}. The total resistance Rₜₒₜₐₗ of the gas sensing platform would be the sum of R_{interconenct} and R_{sensing}.

For an applied voltage of V, the current in the device is V/(R_{interconenct}+R_{sensing}), so the power in the sensing region for Joule heating is given as R_{sensing}*V\hat{ }2/(R_{interconenct}+R_{sensing})\hat{ }2=V\hat{ }2/R_{sensing}*1/[1+(R_{interconenct}/R_{sensing})]\hat{ }2. Therefore, a small R_{interconenct}/R_{sensing} ratio and a small R_{sensing} are desired for a high power in the sensing region for a high self-heating temperature.

Therefore, R_{sensing} should be kept small but the ratio of the resistance of the sensing region R_{sensing} relative to the resistance of the interconnect region R_{interconenct} is better to be as large as possible. Typically, a ratio of 10:1, 100:1 or 1000:1 may be used.

A response is defined as a ratio (R₀−R)/R₀, wherein R₀ is a resistance of the sensing region in the presence of only air, while R is the resistance of the sensing region in the presence of the gas to be detected. The response can vary a lot depending on the nanomaterial, target gas, and its concentration. As long as the response is three times larger than the noise, it can be detected by the sensing platform of the present invention. A response as low as ˜0.0001 has been observed in measurements, but it can be much larger for a larger gas concentration.

A balance has to be struck between the significant response and fast response/recovery. The recovery ratio is defined as the ratio of responses at the end to the start of desorption in given time duration. Both the response and recovery depend on the LIG sensing region geometric parameters (thickness, width and length), laser scribing parameters (i.e., the nanostructure of the LIG sensing region), the operating temperature, various nanomaterials decorating the LIG sensing region, the target gas and its concentration, etc. In one example, the response of the sensor decreases from 6.6‰ to 2.0‰ as the operating temperature increases from 20° C. to 80° C. and the recovery rate increases from 58% to 113%. Considering the balance between the significant response and fast response/recovery processes, the operating temperature of around 60° C. is selected as an optimum operating temperature. The room or low temperature sensing capability is particularly attractive for wearable gas sensing applications due to low energy consumption and the elimination of the adverse thermal effect on the skin surface. Though the operating temperature of 60° C. seems to be slightly higher than the desired temperature in the epidermal applications, incorporating a heat sink or combining the thermal isolation layer in the gas sensor could readily reduce the temperature at the sensor/skin interface to avoid an adverse thermal effect on the skin surface.

In one example, using a sensing platform in accordance with an embodiment of the present invention, at a proper self-heating condition to 60° C., the rGO/MoS₂-LIG gas sensor exhibits fast response/recovery and ultrasensitive detection of NO₂, with a limit of detection of approximately 1.5 parts per billion (ppb) at low power. When designed in a stretchable pattern, the LIG gas sensing platform can withstand a uniaxial tensile strain of 20% that is comparable to the level of maximum deformation on the skin surface to open new opportunities for the epidermal electronic devices.

The graphene-based gas sensing platform may be designed to consist of a straight sensing region and a straight interconnect region, or a straight sensing region and a nonlinear interconnect region, or a nonlinear sensing region and a nonlinear interconnect region. Preferably, a wearable or stretchable gas sensing platform may be designed to consist of a straight sensing region and a nonlinear interconnect region such as a wavy or serpentine interconnect region. The interconnect region at two ends of the sensing region may be facing the same direction or opposite to each other.

The present invention also provides methods of fabricating the gas testing platform based on porous graphene. In an example, a carbon-containing source material is disposed on a substrate. The carbon-containing source material may be polyimide films, modified polyimide and phenolic resin, lignocellulose materials, polyetherimide (PEI), sulfonated poly(ether ether ketone), polysulfone, polyethersulfone, or naturally occurring wood.

The carbon-containing source material may have a variety of thicknesses. A non-limiting example of the thickness is 90 μm. The thickness can contribute to a larger surface to volume ratio in a given area (or footprint) for enhanced sensitivity.

In an example, porous laser-induced graphene patterns are formed on the top surface of the carbon-containing source material by photothermal ablation. The laser-induced graphene patterns are then cut and removed from the substrate and subsequently placed on a rigid or flexible or stretchable substrate. The interconnect region is then coated with a metal layer to provide electrical connection to the external data acquisition system. Nanomaterials such as MoS₂, rGO/MoS₂, or ZnO/CuO core/shell nanomaterials are deposited in the graphene sensing region.

As a result, a highly sensitive stretchable gas sensing platform based on a porous laser-induced graphene sensing region and a metal/laser-induced graphene interconnect region is formed. The laser-induced graphene gas sensing platform acts as a chemiresistor under an externally applied voltage. The metal surface coating on the laser-induced graphene in the interconnect region induces location-dependent conductivity to significantly reduce its resistance, which enables highly localized Joule heating (i.e., self-heating) in the sensing region during the measurement of the chemiresistor. The integrated self-heating capability in the laser-induced graphene gas sensing platform is fast (to reach equilibrium within 20 s) and well-controlled (by externally applied voltage) and significantly reduces the fabrication complexity. Highly sensitive nanomaterials such as MoS₂ and rGO/MoS₂ dispersed on the laser-induced graphene sensing region result in an ultrasensitive chemoresistive gas sensor for detecting NO₂. Other nanomaterials can be used for other gases. Due to the large specific surface area in the nanomaterials and highly porous laser-induced graphene, rich yet specific active sites in the nanomaterials, and possible formation of p-n heterojunctions in the sensing region, the resulting gas sensor exhibits relatively large response, fast response/recovery processes, and excellent selectivity at ambient and slightly elevated temperatures. The preferred temperature for operating the gas sensor of the present invention is in the range of 20-100° C., more preferably 20-40° C., and more preferably 25-37° C.

The drastically reduced noise levels result in a significantly increased signal-to-noise (e.g., close to 900 to NO₂ of 1 ppm), which enables the sensor to detect NO₂ at a concentration of smaller than a few ppb, even smaller than 1 ppb. If the interconnect region is configured in a stretchable serpentine or other non-linear layout, the resulting laser-induced graphene gas sensing platform becomes mechanically robust even under a uniaxial tensile strain, such as a strain of 20%, that is comparable to the maximum deformation on the skin surface. The strain interfering could be further minimized using other stretchable strategies such as incorporating a stiffer material in the sensing region, e.g., leaving a smaller area of the carbon-containing film used for fabricating the porous-graphene around the sensing region. Other strain-isolating strategies such as pre-strain of the substrate, self-similar interconnect patterns, and kirigami patterning of the substrate may also be used to prepare a stretchable structure.

A heat sink or a thermal isolation layer may be incorporated in the gas sensor to avoid an adverse thermal effect on the skin surface.

A high-density gas sensor array, comprising an array of the gas sensing platforms in accordance with the embodiments of the present invention, can be formed to deconvolute various gaseous components in a gas mixture, where the respective sensing region of each gas sensing platform in the array is decorated with a different gas-sensitive nanomaterial.

As used herein, porous graphene refers to substantially pure graphene with 3D foam structure and can be induced from carbon source materials by lasers or focused irradiation or any other energy sources with comparable energy intensities. The term “substantially pure” means that the graphene is close enough to pure to perform as described herein and that the graphene does not include substantial amounts of other materials such as graphene oxide. In examples, the graphene is substantially pure before the nanomaterials are disposed thereon. The nanomaterials disposed on the graphene are considered separately. Nanomaterials refer to rGO, MoS₂, rGO/MoS₂, ZnO/CuO core/shell nanomaterials, carbon nanotubes, one dimensional nanostructured metal-oxides, graphene/metal oxide hybrid or other nanomaterials selected for detection of different gases. Nanomaterials can be added to the graphene by drop casting, physical vapor deposition, chemical vapor deposition, electroplating, or any other suitable means. Conductive materials refer to metals, semiconductors, and some nonmetallic conductors such as graphite and conductive polymers.

### Examples

In the following sections, the fabrication and characteristics of the graphene-based gas sensing platform of the present invention will be described in more detail using examples. The effects of the laser-induced graphene sensing region geometric parameters, operating temperature, and various nanomaterials on the gas sensing performance will also be systematically described. It is noted that other embodiments may be used and are not limited to these specific examples.

Fabrication of the Gas Testing Platform Based on Laser-Induced Graphene

In this example, the stretchable, highly porous laser-induced graphene (LIG) gas sensing platform is created by using a simple laser scribing process with a selective coating of metal layer in the serpentine interconnect region.

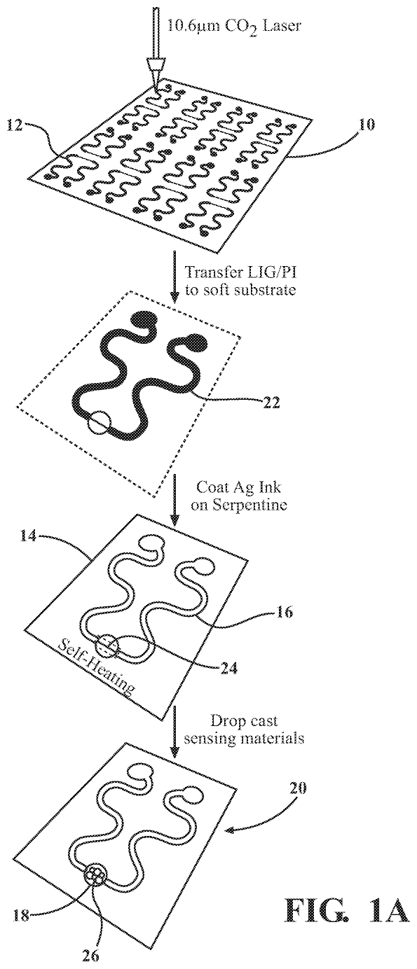

In brief, FIG. 1 illustrates an exemplary fabrication process of preparing the stretchable LIG gas sensing platform 20: creating porous LIG patterns 12 on a polyimide (PI) film 10 by a laser scribing process; transferring the LIG/PI pattern 12 onto a soft elastomeric substrate 14; coating the wavy serpentine interconnect regions 22 with a conductive material 16 such as the silver ink 16; and depositing gas-sensitive nanomaterials 26 onto the graphene gas sensing region 24. In this example, the gas sensing platform includes a straight graphene sensing region 24 on a circular area 18 between serpentine interconnect regions 22. The interconnect regions 22 may be covered with a conductive material layer 16. The circular area 18 is a small area cut from the PI film. The nanomaterials 26 disposed on and around the straight graphene sensing region make up for part of the sensing region as well. It is optional whether to cut off a small piece of PI film 18 around the sensing region 24. Both the small PI film 18 and the substrate 14 can act as a thermal barrier for the gas sensing platform.

Computer-designed layouts of porous LIG patterns on polyimide (PI) films can be rapidly formed with high precision in an ambient environment by using a laser system, with the remaining PI underneath the LIG to ensure its mechanical integrity. The LIG pattern is transferred onto a soft elastomeric substrate. Silver ink (Novacentrix AJ-191) is then drop-cast or otherwise coated in the serpentine interconnect region to yield a stretchable LIG gas sensing platform. While it is possible to separately fabricate the LIG sensing region and the Silver wavy serpentine interconnect region, the creation of the Silver pattern would involve more complicated fabrication processes. Additionally, the significantly reduced contact area and quality at the Ag/LIG interface would lead to poor mechanical robustness, especially upon mechanical perturbations such as various skin deformations. Drop-casting or otherwise adding various highly sensitive nanomaterials (e.g., rGO, MoS₂, rGO/MoS₂, or ZnO/CuO core/shell nanomaterials) in the LIG sensing region of the individual gas sensor in the array completes the fabrication of the stretchable gas sensing platform.

Various sensitive nanomaterials dispersed at the LIG sensing region could be designed with high selectivity to detect a specific component or with different selectivity to various components in the gaseous mixture upon various self-heating conditions. Collectively, the sensing response from the sensor array enables combinatorial sensing of multiple gas components in the mixture.

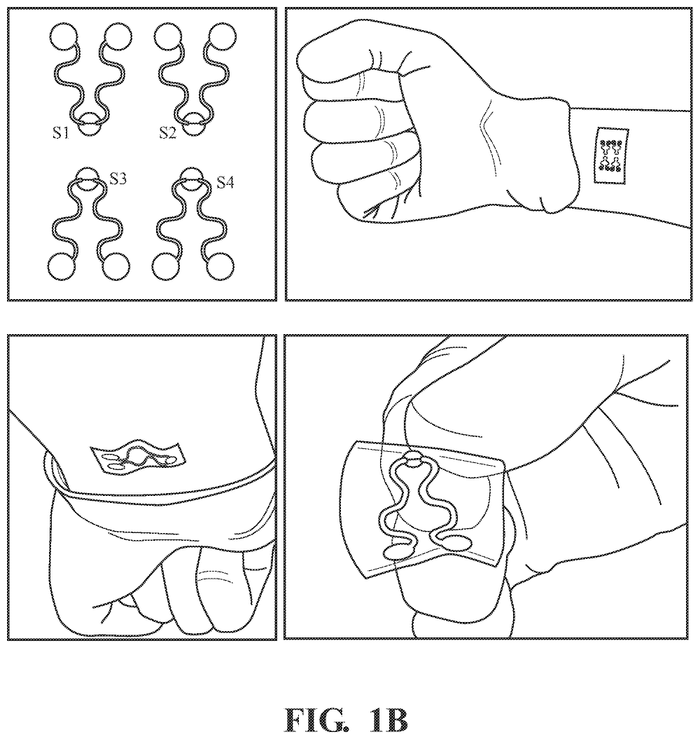

In a representative demonstration, four different sensing units (S1-S4) arranged in an array of two by two on a soft substrate are shown top left in FIG. 1B. Top right of FIG. 1B shows that the array conformed to the wrist of a person even upon the skin deformation from making a fist. Bottom left and right of FIG. 1B show deformations of a single sensing unit on a human wrist and in bending respectively. Each sensing unit is capable of bending to a cylinder, as further shown in FIG. 2A where the cylinder has with a radius of 5.53 mm. FIG. 2B shows a gas sensing unit attached to the back of a hand.

In an example, a LIG gas sensing platform in accordance with an embodiment of the present invention is fabricated hereinbelow. A polyimide (PI) film (Kapton HN, 90 μm thickness) laminated on a water-soluble tape (3M, 5414 tapes) was first attached on glass slides by a double-sided tape. Upon direct CO₂ laser (Universal Laser, 10.6 μm) scribing with a power of 16% and speed of 10%, porous laser-induced graphene patterns formed on the top surface of the PI film by photothermal ablation. The same laser system with a lower power of 5% and lower scanning rate of 1% enabled the cutting of LIG patterns. Immersing the resulting sample in water dissolved the water-soluble tape and released the LIG patterns from the glass substrate. Rinsing the LIG surface with ethanol and water subsequently with mild agitation removed the dust and contaminants. After attaching the LIG to a water-soluble tape with gentle pressure, a thin Ecoflex (Smooth-on, Ecoflex 00-30) layer with a thickness of 500 μm was cast on the back of PI surface and cured at 60° C. on a hot plate for one hour. Dissolving the water-soluble tape exposed the LIG pattern with two serpentine lines (width of 2 mm) and a single straight line with various lengths and widths. Coating the serpentine lines with silver ink (Novacentrix AJ-191) reduced their electrical resistances to provide electrical connection to the external data acquisition system. Drop casting nanomaterials such as MoS₂, rGO/MoS₂, or ZnO/CuO core/shell nanomaterials in the LIG single line sensing region completed the fabrication of a highly sensitive stretchable gas sensor.

Preparation of the ZnO/CuO core/Sheel Nanomaterials

Intergrowth Cu₂(nbdc)₂(dabco) on Zn₂(nbdc)₂(dabco) was synthesized by the conventional seeded growth method. In a typical procedure, Cu(NO₃)₂.3H₂O was dissolved in N,N-dimethylformamide (DMF). Next, acid linker 3-Nitrophthalic acid (3-nitrobenzenedicarboxylic acid, nbdc) was dissolved in DMF. Base (pyridine) was then added with micropipette into base linker dabco (1,4-diazabicyclo[2.2.2]octane) solution in DMF. 66 μL seed dispersion (0.1% conventional Zn₂(nbdc)₂(dabco) pillared metal-organic framework (MOF) suspension in DMF (wt %)) was added into the base solution. Once the linkers and metal salt were completely dissolved, metal solutions and acid linkers were added into the seed solution. The final mixture with a molar ratio of metal salt:nbdc:dabco:base:DMF=2.8:2:2:40:24000 was shaken on an orbital shaker at 200 rpm for 48 hours. The solid in the resulting suspension was separated using centrifugation (4000 RCF). The obtained bimetallic MOF was then used to prepare the mixed metal oxide nanomaterials. Intergrowth MOF Cu₂(nbdc)₂(dabco)-on-Zn₂(nbdc)₂(dabco) of 100 mg was heated in N₂ (50 SCCM) at 400° C. (ramp rate of 1° C./min) for 10 hours followed by dry air (50 SCCM) at 400° C. for another 10 hours. The obtained ZnO/CuO core/shell nanomaterials were cooled to room temperature in dry air.

Synthesis of rGO/MoS₂ Composite

The rGO/MoS₂ composites were prepared by a solvothermal method. In brief, 24 mg MoO₃, 28 mg thioacetamide, and 0.2 g urea were dissolved in 16 ml ethanol with continuous magnetic stirring for 1 h, followed by adding 4 ml GO suspension of 3.5 mg/ml. Next, the well-mixed solution was transferred to an autoclave and loaded into a furnace (MTI). Heating the furnace to 200° C. and then the temperature was maintained for 16 h. Removing the autoclave from the oven rapidly cooled down the solution to room temperature and terminated the reaction. The as-prepared rGO/MoS₂ composite was collected and washed with deionized water and then ethanol, followed by storage in the mixture of deionized water and ethanol at the volume ratio of 1:1 before use.

The confined growth of the rGO/MoS₂ composites followed the same recipe as above. 12 mg MoO₃, 14 mg thioacetamide, and 0.1 g urea were dissolved in 8 ml ethanol with continuous magnetic stirring for 1 h, followed by adding 2 ml GO suspension of 3.5 mg/ml. After transferring the 10 ml reactant suspension into the autoclave reactor, 20 ml NaCl crystal fillers (Morton Salt, as-bought) were added into the reactor slowly with agitation. After the reactor was placed still for 5 min, the supernatant liquid was removed (the liquid existed only between the crystal fillers). After maintaining the temperature at 200° C. for 16 h, the as-prepared rGO/MoS₂ filled in the confined spaces formed by crystal fillers. The crystal fillers were dissolved by water to collect the products, and the obtained products were washed by deionized water for at least five times. Finally, the black dispersive rGO/MoS₂ product was dialyzed with deionized water for at least seven days using regenerated cellulose dialysis membranes until no smell.

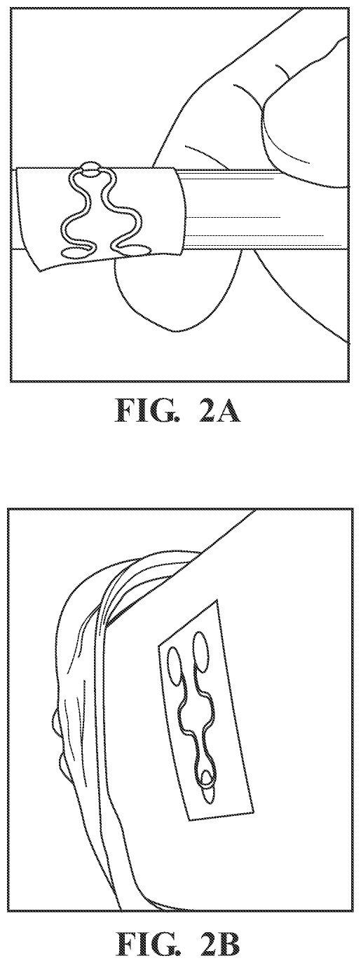

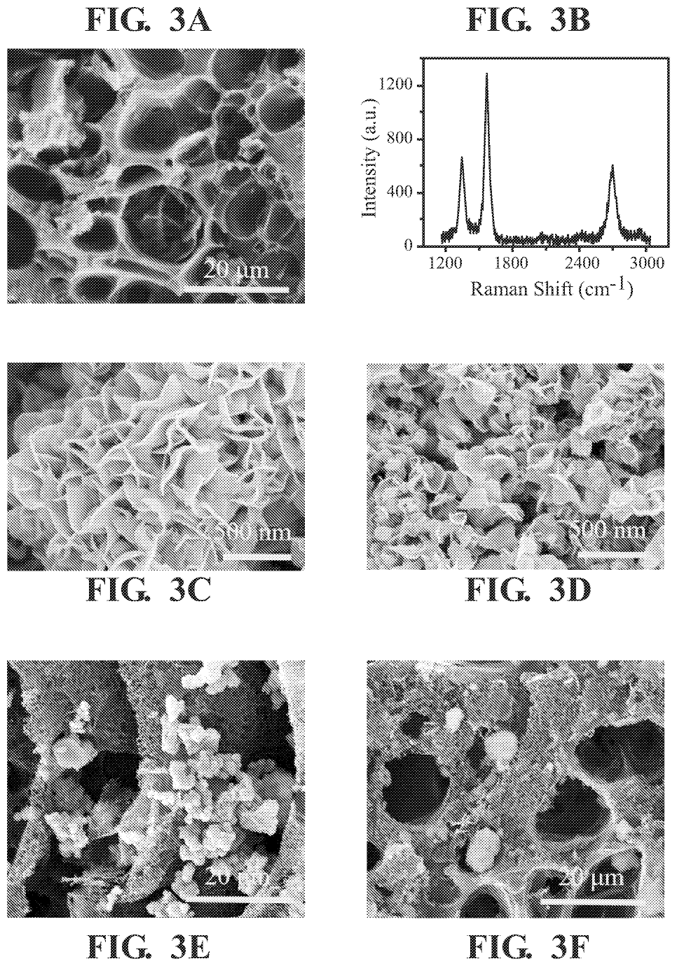

In brief, FIGS. 3A-3F illustrate characterization of the LIG gas sensing platform. FIGS. 3A-3B show a SEM image and a Raman spectrum of porous LIG electrode, respectively. FIGS. 3C and 3D show SEM images of rGO/MoS₂ nanoflowers synthesized without and with the as-bought NaCl salt crystals respectively, resulting in “large petal” or “small petal” nanoflower structures. FIGS. 2e-2f show SEM images of rGO/MoS₂ nanoflowers with “large petal” and “small petal” structures dispersed on the porous LIG electrodes, respectively.

As shown in FIG. 3A, the laser scribing process yielded continuous, porous LIG structures. The Raman spectrum of the LIG in FIG. 3B also exhibited the D peak (˜1350 cm⁻¹), G peak (˜1572 cm⁻¹), and 2D peak (˜2697 cm⁻¹), with a relative large ratio of I_{G}/I_{2D} to indicate the presence of few-layered porous graphene. The sensitive nanomaterial with high selectivity is chosen to detect a specific gaseous component in the mixture. Collectively, the sensing response from different sensors in the high-density array enables deconvolution of multiple gaseous components in the mixture relevant to the healthcare or environmental applications. The design example of the NO₂ gas sensor includes the use of low-dimensional nanomaterials such as MoS₂ and rGO/MoS₂ with controlled surface morphologies. Considering the intrinsic p-type semiconducting LIG, introducing n-type MoS₂ nanomaterials on LIG could form p-n junctions to enhance the sensing performance. The versatility of the LIG gas sensing platform will be explained hereinbelow by exploring it to characterize heterostructure metal oxides. As a representative heterostructure metal oxide, ZnO/CuO core/shell nanomaterials prepared by calcination of a Cu—Zn bimetallic metal-oxide framework (MOF) will be used.

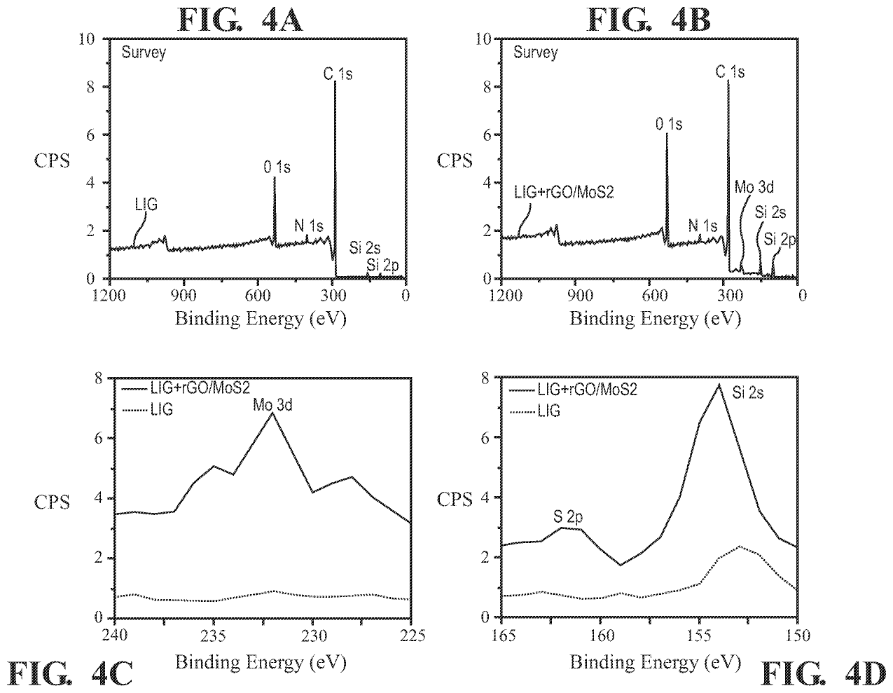

The rGO/MoS₂ composite solution is prepared as follows. In brief, as received NaCl crystal fillers were added to a mixture of precursors (i.e., molybdenum oxide, thioacetamide, urea, and GO), the NaCl crystal fillers created the confined space among them, allowing the rGO/MoS₂ to synthesize only within such a confined space. The morphology of the rGO/MoS₂ was also regulated by the size of the confined space. Two different rGO/MoS₂ samples were synthesized without or with as-bought NaCl crystal fillers. As characterized by the scanning electron microscopy (SEM), the rGO/MoS₂ composites exhibit hierarchical flower-like structures consisting of a large number of petals, as shown in FIGS. 3C-3D. The resulting rGO/MoS₂ nanoflower is associated with large specific surface area. The rGO/MoS₂ nanoflower synthesized with as-bought NaCl crystal fillers exhibit smaller sample size and higher specific surface area (“small petal”) shown in FIG. 3D than that synthesized without salt (“big petal”) shown in FIG. 3C. A proper ratio of rGO to MoS₂ is also desired, when the rGO concentration is over 0.5 mg/ml and the MoS₂ concentration is in the range from 0.64 to 1.28 mg/ml, because too much rGO will shield gas sorption sites on MoS₂ and too little rGO will reduce the conducting pathway. Both of the rGO/MoS₂ samples have a MoS₂ concentration of 1.33 mg/ml and an rGO concentration of 0.7 mg/ml. The rGO/MoS₂ composite solutions were then drop cast in the LIG sensing region to yield the stretchable gas sensor. The successful integration of rGO/MoS₂ nanoflowers on the porous LIG sensing region was confirmed by the SEM, shown in FIGS. 2e-2f. The formed interconnected network has a small contact resistance, which is beneficial for gas sensing performance. The elemental compositions of the LIG gas sensors before and after dispersing rGO/MoS₂ were also examined by X-ray photoelectron spectra (XPS). Ascribing the Si 2s, Si 2p, and O 1s peaks to the siloxane of the PDMS substrate, the survey spectrum of bare LIG samples shown in FIG. 4A indicates the presence of the LIG on PDMS. Compared with survey spectrum of bare LIG samples, the survey spectrum of LIG with rGO/MoS₂ synthesized using NaCl crystals informs the presence of MoS₂ on the LIG, shown in FIG. 4B. The characteristic features of MoS₂ have been observed: Mo 3d doublet centered at the binding energy of 232 eV and 228 eV in FIG. 4C and the S 2p peak centered at 162 eV in FIG. 4D. It should be noted that it is difficult to control and calculate the ratio of rGO/MoS₂ over LIG though the volume of the rGO/MoS₂ solution could be accurately controlled in drop casting.

Though room temperature gas sensors eliminated the adverse thermal effect, moderate heating in gas sensing materials (e.g., graphene/MoS₂) is still favorable to enable fast response/recovery and enhanced reversibility. The self-heating effect of the LIG gas sensing platform could be exploited to reduce the device complexity for characterizing various gas-sensitive nanomaterials.

The self-heating effect of the LIG gas sensing platform hinges on its geometric parameters and location-dependent conductivity (i.e., Silver coated LIG in the serpentine interconnect region). A strong self-heating effect requires the resistance of the LIG sensing region to be significantly larger than that of the serpentine region. Similar to the conventional design of heaters, a smaller linewidth and a longer length in the LIG sensing region increased its relative resistance to the serpentine interconnect region. However, the Ag ink coating in the serpentine interconnect region drastically reduced its resistance, obviating the need for a significantly reduced linewidth and increased length in the LIG heating region. While the laser processing parameters change the sheet resistance of the LIG, the additional change in the linewidth and length of the LIG sensing region further provides ways to tune the resistance of the LIG sensing region.

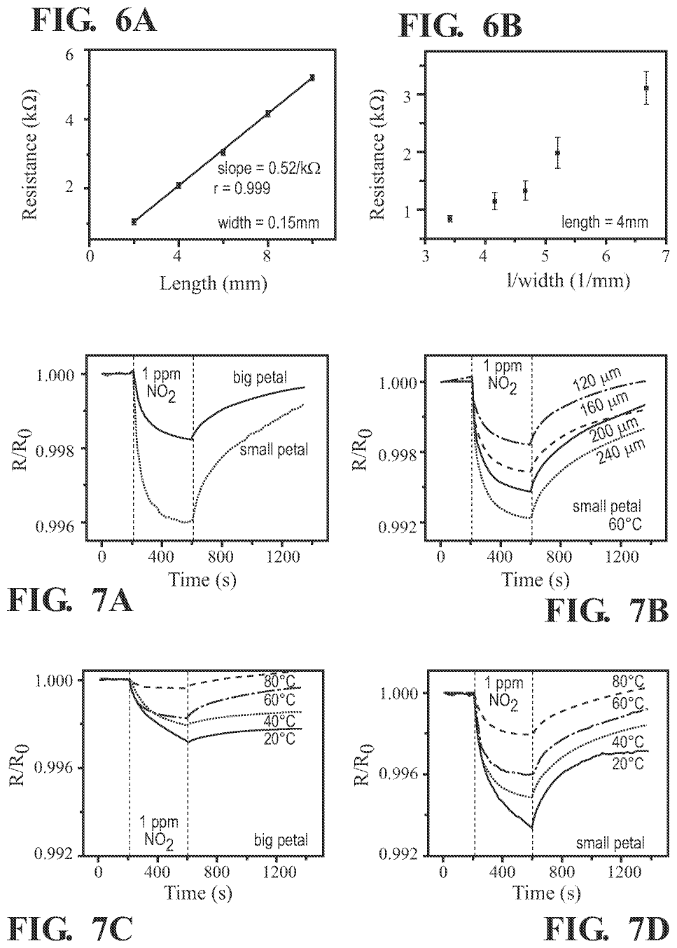

FIGS. 6A-6B are illustrations showing dependence of the resistance of the LIG electrode on its length and width respectively. Given the same laser processing parameters, the resistance of the LIG sensing region was found to be proportional to its length, shown in FIG. 6A, yielding a sheet resistance of 78 Ω/sq. Though the resistance decreased as the width increased, the inverse proportional relationship was not observed, as can be seen in FIG. 6A, because of the change in the sheet resistance (ranging from 110 Ω/sq to 60 Ω/sq with the increasing width from 150 μm to 292 μm) from creating the LIG pattern of different widths.

FIGS. 7A-7D show effects of the width and operating temperature from self-heating on the gas sensing performance. In brief, FIG. 7A shows the typical response curves of rGO/MoS₂ nanoflowers with the small petal and big petal structure on the LIG sensing platform at 60° C. to NO₂ of 1 ppm. FIG. 7B shows time-dependent response curves of rGO/MoS₂ nanoflowers with the small petal on the LIG with various widths at 60° C. FIG. 7C shows sensor response of rGO/MoS₂ nanoflowers with the big petal to 1 ppm NO₂ at various temperatures from self-heating. FIG. 7D shows sensor response of rGO/MoS₂ nanoflowers with the small petal to 1 ppm NO₂ at various temperatures from self-heating.

The transient Joule heating was characterized for the LIG sensing region with a length of 2.5 mm and width of 120 μm (an initial resistance of ˜2.3 kΩ), as shown in FIG. 7A. The peak temperature rapidly increased to equilibrium for an applied voltage in the range from 0.5 V to 12 V. The time to equilibrium is less than 20 s.

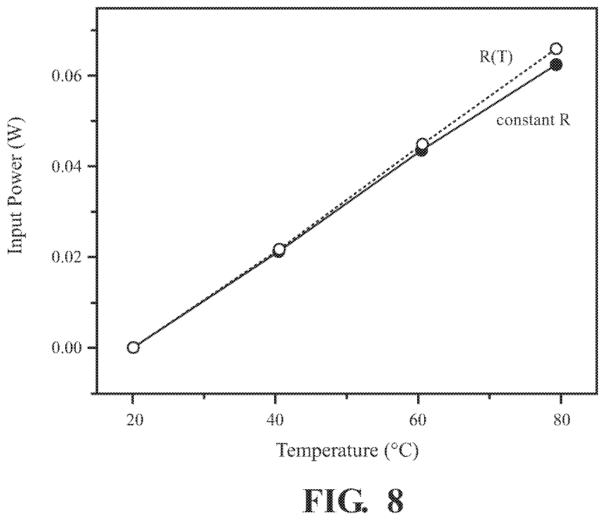

FIG. 8 shows dependence of the temperature in the LIG electrode from self-heating on the input power, in which the solid black line assumes a constant resistance over time and the dashed red line uses the real-time resistance that decreased with the increasing temperature.

As the Joule heating induced temperature rise linearly scales with the input power applied on the LIG sensing region, a higher applied voltage in this range induced a higher temperature, as illustrated in FIG. 8. The localized heating and temperature rise from Joule heating in the LIG sensing region due to its relatively high resistance in comparison with the Ag/LIG serpentine interconnect region are confirmed by the infrared thermal images of the LIG surface. The temperature of the gas sensing region was controlled to 20.1° C., 39.8° C., 60.4° C., and 80.1° C., by applying a voltage of 0.5 V, 7 V, 10 V, and 12 V, respectively.

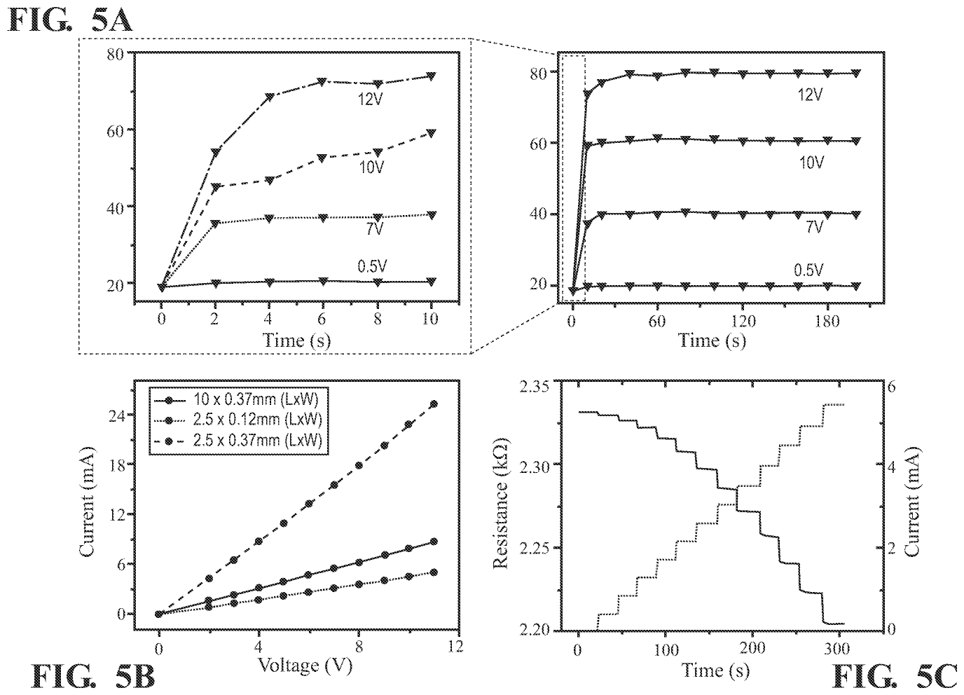

FIGS. 5A-5C illustrate characterization of the LIG electrode with self-heating capabilities. FIG. 5A shows the time-dependent temperature profile of the LIG electrode when different input voltages were applied during the resistance measurement of the chemiresistor. The inset shows the zoom-in of the measurement in the first 10 s. FIG. 5B shows current-voltage (I-V) curves of three LIG electrodes with different sizes. FIG. 5C shows the change in resistance of and current in the LIG electrode with a length of 2.5 mm and width of 120 μm as a function of the time.

The steady-state characteristics of the LIG gas sensing platforms were analyzed by measuring their current-voltage (I-V) curves with different sizes in the LIG sensing region, shown in FIG. 5B. In the I-V curve measurement, the voltage was ramped up from 0 V to 11 V in a stepwise manner (i.e., step increase of 1 V per 20 s). Though the I-V curves were relatively linear despite the temperature rise from self-heating, there was still a small change in the resistance of the LIG gas sensing platform. Taking the LIG sensing region with a length of 2.5 mm and width of 120 μm as an example, its resistance was shown to decrease, as can be seen in FIG. 5C, because of the negative temperature coefficient in the graphitic materials. However, the resistance reduction was small to be negligible, as the resistance of the LIG gas sensing platform only gradually decreased from 2.331 kΩ to 2.220 kΩ by 4.7% in the voltage range from 0 V to 11 V. By considering the small variation in the electrical resistance of the LIG gas sensing platform, an improved agreement was observed between the temperature rise and the input power, as indicated by FIG. 8. Because of the relatively stable resistance, the current in the LIG gas sensing platform was observed to ramp up in a stepwise manner from 0 mA to 5.44 mA, shown in FIG. 5C.

The sensing mechanism of the chemiresistive gas sensor relies on the direct charge transfer between the target gas molecules (e.g., NO₂) and sensitive nanomaterials (e.g., MoS₂, rGO/MoS₂, or ZnO/CuO core/shell nanomaterials). In the rGO/MoS₂ nanoflowers, while the p-type rGO sheets provide the overall conductivity, the n-type MoS₂ on the rGO sheets has multiple active sites with selective affinity to NO₂ gas molecules for sensing. The adsorption of NO₂ on the surface of rGO/MoS₂ nanoflowers continuously withdrew electrons from rGO/MoS₂, which extended both of the electron depletion and hole accumulation regions at the interface of the p-n junction. The accumulation of holes increases the major carrier concentration of the gas sensor, thereby decreasing the overall resistance.

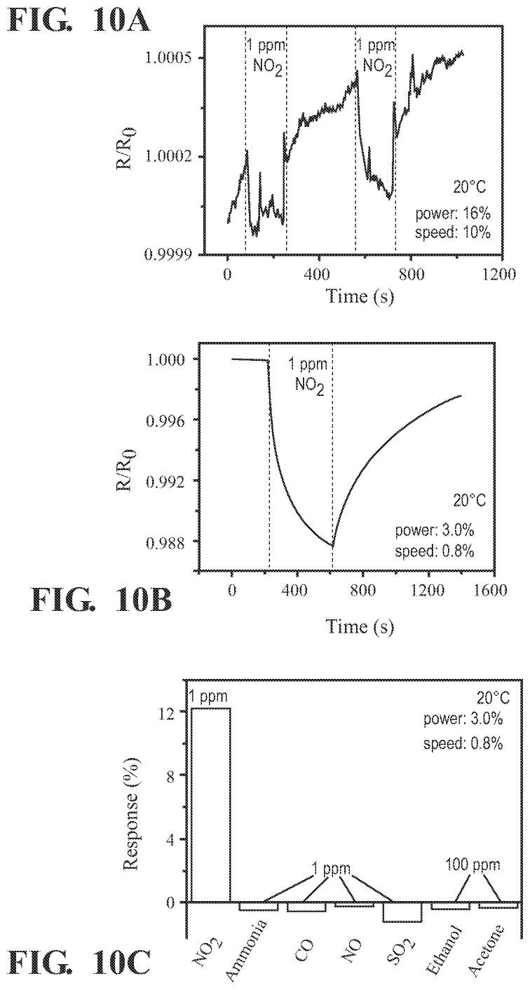

FIGS. 10A-10C show the gas sensing response observed in the pristine LIG to NO₂ of 1 ppm at 20° C. when (a) a power of 16% and a speed of 10% or (b) a power of 3% and a speed of 0.8% were used in the laser scribing process. FIG. 10C shows the selectivity of the pristine LIG line in FIG. 10B.

It should be pointed out that the carrier concentration of the LIG changes upon NO₂ adsorption is evidenced by its response to NO₂ gas molecules. The gas sensor response was defined as the ratio of its electrical resistance R in the presence of target gas to that R₀ in the air. The gas sensing response of pristine porous LIG sensing regions to NO₂ was observed to depend on the laser scribing parameters. When a power of 16% and a speed of 10% were used in the CO₂ laser scribing process, the resulting LIG sensing regions showed poor sensitivity (˜0.3‰) and apparent baseline shift when exposed to 1 ppm NO₂ at 20° C., shown in FIG. 10A. Reducing both the power and speed in the laser scribing process (power of 3% and speed of 0.8%) yielded pristine porous LIG sensing regions with significantly improved performance (i.e., response of 12‰ and SNR of 434), shown in FIG. 10B. Meanwhile, the excellent selectivity of the sensor to NO₂ over a wide range of other inferencing gas species (e.g., acetone, ethanol, ammonia, SO₂, CO, and NO) was also confirmed in FIG. 10C. In addition to the change in laser scribing parameters, dispersing highly sensitive materials such as MoS₂ shown in FIG. 11 or rGO/MoS₂ shown in FIG. 7A in the LIG sensing regions also improved the gas sensing performance to NO₂. For instance, the response of the porous LIG line (power of 16%, speed of 10%) coated with rGO/MoS₂ (or MoS₂) exhibited significant increase to 7‰ (or 5‰), corresponding to ca. 20-fold increase when compared to the pristine porous LIG sensing regions without nanomaterial coating. Upon NO₂ exposure of 6 min, a high SNR of 482 (or 285) was also observed in the LIG sensing region coated with rGO/MoS₂ (or MoS₂). Considering the vast difference between sensors with and without the highly sensitive nanomaterials, the response of the gas sensor should be mainly contributed by the nanomaterials, which demonstrates that the LIG gas sensing platform enables the characterization of sensitive nanomaterials.

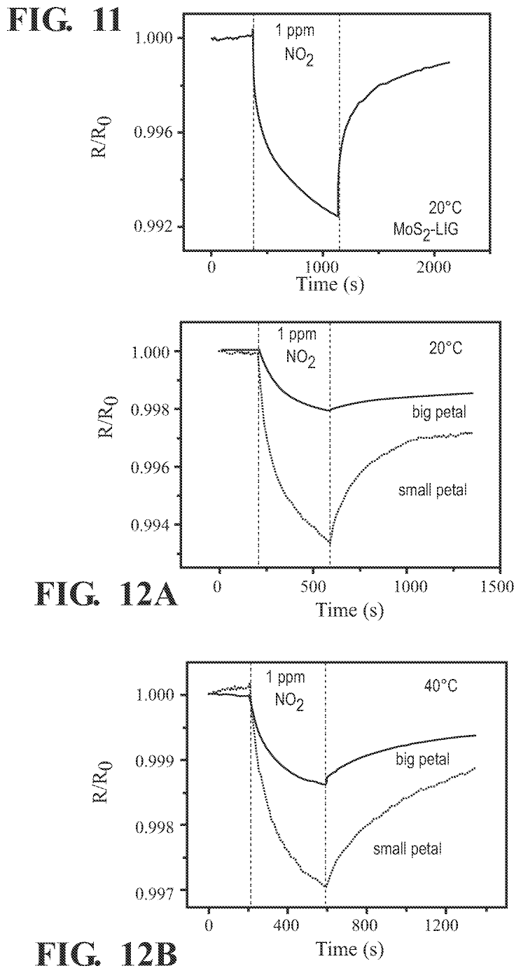

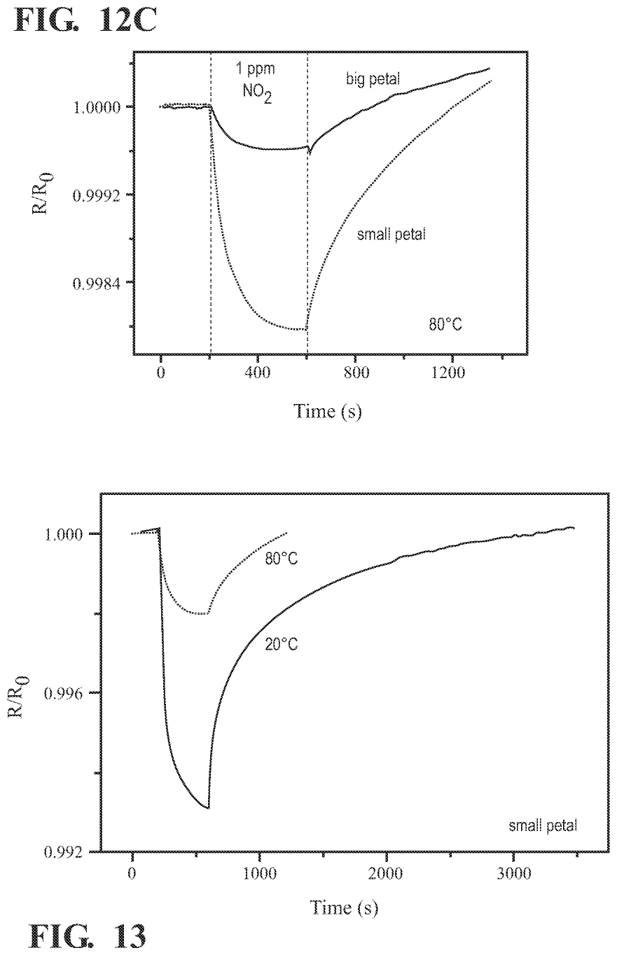

The rGO/MoS₂ nanoflowers with the small petal structure was selected to investigate the width effect on the gas sensor performance, because it demonstrated a more substantial response of 4.0‰ than that with the big petal structure of 1.8‰ to NO₂ of 1 ppm at 60° C. from self-heating (10 V applied on the LIG with a linewidth of 120 μm and length of 2.5 mm), shown in FIG. 7A. The more significant response in the LIG with the small petal structure than that with the big petal structure was also observed at other temperature values, i.e., 6.6‰ vs. 2.8‰ at 20° C., 5.1‰ vs. 2.0‰ at 40° C., and 2.0‰ vs. 0.4‰ at 80° C., shown in FIG. 12. The LIG with the small petal structure is associated with the reduced feature size and more uniform distribution of the nanomaterials. The increased specific surface area and the possibly formed p-n junction lead to a more substantial response and faster response/recovery processes. The angle of the plateau is introduced and defined as the tangent angle of the response/recovery curves at the end of adsorption/desorption to quantitatively capture these processes. The smaller the angle of the plateau, the faster the response/recovery processes. With such a new definition, the response process in the LIG with the small petal structure (angle of the plateau of 2°) was indeed faster than that with the big petal structure (slope of the plateau of 3°).

Different voltage inputs were first applied to the LIG sensing region with various linewidths to ensure their temperatures remained the same such as at 60° C. In particular, a voltage of 20 V, 15 V, 12 V, and 11 V was applied on the LIG with a linewidth of 120 μm, 160 μm, 200 μm, and 240 μm, all with the same length of 6 mm. Next, dispersing rGO/MoS₂ nanoflowers with small petal structure on the LIG sensing region with various linewidths prepared chemiresistive gas sensors. The electrical resistance of the resulting gas sensors decreased upon exposure to NO₂ of 1 ppm and recovered in the air due to the desorption of NO₂, as shown in FIG. 7B. The magnitude of the response to NO₂ of 1 ppm at 60° C. increased from 3‰ to 8‰ as the linewidth of LIG sensing region increased from 120 μm to 240 μm. Consisting of the electrical resistance R_{sensing} in the sensing region, Rₛₑᵣₚₑₙₜᵢₙₑ in the serpentine region, and the contact resistance R_{contact} between nanomaterials (e.g., rGO/MoS₂) and LIG, the total resistance Rₜₒₜₐₗ of the resulting gas sensor would be the sum of the three. Forming a parallel connection between the LIG and the nanomaterial such as rGO/MoS₂ would indicate a more significant response in the LIG with a smaller linewidth, which cannot explain the trend in the experiment. The increased response with the increasing linewidth could be likely attributed to the non-uniform temperature distribution in the LIG sensing region, as shown in FIG. 8. Non-uniform temperature distribution resulted in a lower temperature at the edge than that at the central region of the LIG sensing region. Because the rGO/MoS₂ sensing material showed a more substantial response at a lower temperature, as shown in FIGS. 7C-7D, the lower temperature at the edge region of the LIG sensing region with a larger linewidth gave rise to the more significant response. Additionally, the incomplete recovery to NO₂ observed in the LIG with a larger linewidth could be explained by the limited recovery at a lower temperature in FIGS. 7C-7D at the edge region from the non-uniform temperature distribution as well.

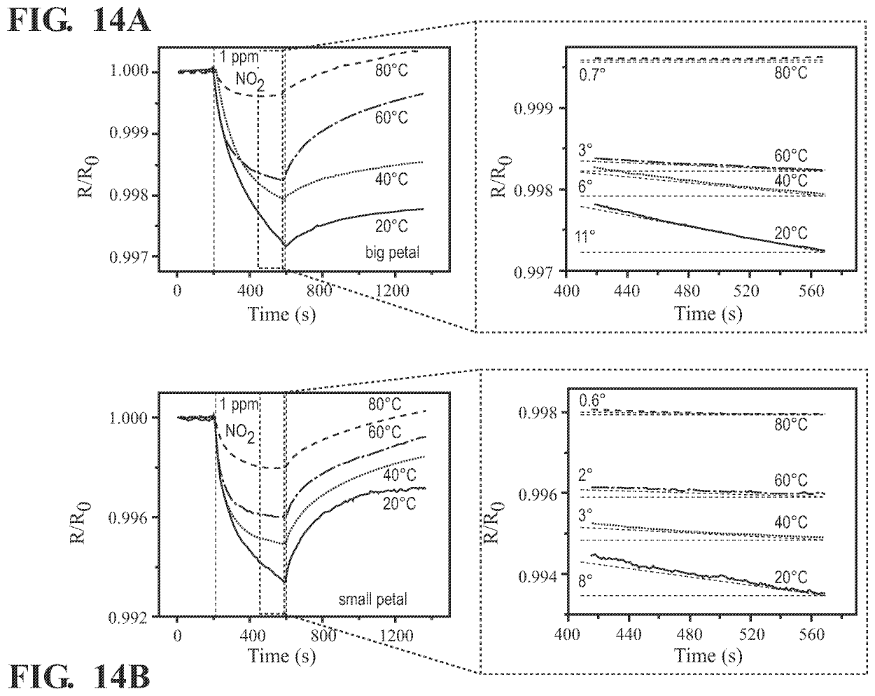

After uncovering the width effect, the temperature effect is investigated on the gas sensor performance. By leveraging the self-heating effect in the LIG sensing region, the gas sensing behaviors of the rGO/MoS₂-LIG sensor to NO₂ of 1 ppm were compared at various operating temperatures from 20° C. to 80° C., shown in FIGS. 7C-7D. The operating temperature was selected to be below 100° C. because of the stability consideration of the ionosorption of gas species in the charge transfer involving MoS₂. While a complete recovery was observed in the LIG gas sensing platform with rGO/MoS₂ nanoflowers of the small petal structure, the recovery time of 2830 s to 1 pm NO₂ at 20° C. was significantly larger than that at 80° C. (580 s), shown in FIG. 13. Also, it is crucial to sensitively detect low concentrations of NO₂ (˜53 ppb) in the envisioned applications, as this level of exposure can cause chronic bronchitis, emphysema, and respiratory irritation. The repeatability test indicates that the response of the gas sensor to the same target gas concentration is independent of whether the gas sensor is fully recovered. Thus, the gas sensor does not necessarily need to fully recover when used for the long-term monitoring of low-level exposures. Considering a recovery time of 720 s is sufficient to capture the gas sensor characteristics, this value is used in the subsequent tests for rapid testing unless otherwise specified. As the operating temperature was increased from 20° C. to 80° C., the response of the sensor with the big petal structure gradually decreased from 2.8‰ to 0.4‰ upon exposure to NO₂ for 6 min, shown in FIG. 7C. While the temperature-dependent response is related to the equilibrium of the NO₂ adsorption, further experiments are still needed to directly uncover the underlying mechanism. However, the elevated operating temperature led to improvements in the response/recovery processes of the gas sensor. The decreased slope of the plateau from 11° to 0.7° indicated the significantly improved response process, as shown in FIG. 14A. Defining the recovery ratio as the ratio of responses at the end to the start of desorption in given time duration, the recovery rate also increased from 20% to 200% for desorption of 12 min as the operating temperature was increased from 20° C. to 80° C. The improved desorption was enabled by thermal activation at elevated operating temperatures.

A balance has to be struck as the significant response and fast response/recovery cannot be achieved simultaneously by tuning the operating temperature alone. This observation also holds for the LIG with the small petal structure. While the response of the sensor decreased from 6.6‰ to 2.0‰ as the operating temperature was increased from 20° C. to 80° C., the angle of plateau decreased from 8° to 0.6°, as shown in FIG. 14B, and the recovery rate increased from 58% to 113%, shown in FIG. 7D. Considering the balance between the significant response and fast response/recovery processes, the operating temperature of 60° C. was selected in the subsequent studies unless specified otherwise. The room or low temperature sensing capability was particularly attractive for wearable gas sensing applications due to low energy consumption and the elimination of the adverse thermal effect on the skin surface. Though the operating temperature of 60° C. seems to be slightly higher than the desired temperature in the epidermal applications, incorporating a heat sink or combining the thermal isolation layer in the gas sensor could readily reduce the temperature at the sensor/skin interface to avoid the adverse thermal effect on the skin surface.

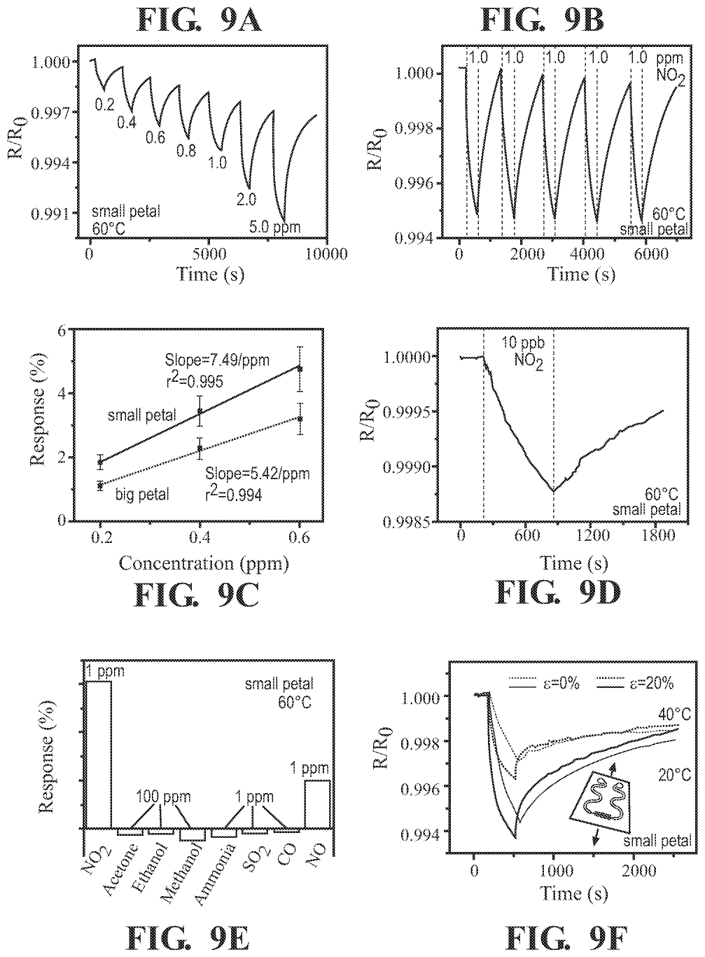

FIGS. 9A-9F show the dynamic response, limit of detection, selectivity, and mechanical robustness of the exemplary gas sensor. In brief, FIG. 9A shows a dynamic response test of the gas sensor with the small petal structure in the presence of NO₂ from 0.2 ppm to 5 ppm at 60° C. from self-heating (applied voltage of 10 V). FIG. 9B is a demonstration of repeatability to NO₂ of 1 ppm for five consecutive cycles. FIG. 9C shows a linear fit to the calibration curves obtained from the sensor response to NO₂ of 200 ppb, 400 ppb, and 600 ppb at 60° C. from self-heating. FIG. 9D is an experimental demonstration of the ultralow limit of detection to NO₂ of 10 ppb at 60° C., where a high SNR of 62 was still measured. FIG. 9E shows the selectivity of the stretchable rGO/MoS₂-LIG gas sensor to NO₂ over a wide range of other inferencing gaseous molecules at 60° C. before stretching. FIGS. 9E and 9F show response of the stretchable gas sensor to NO₂ of 1 ppm before and after a uniaxial tensile strain of 20% was applied at room temperature and 40° C., respectively.

In the typical dynamic response test, the rGO/MoS₂-LIG sensor showed a response of 1.80‰, 2.90‰, 3.96‰, 4.70‰, 5.30‰, 7.60‰, and 9.50‰ as the concentration of NO₂ was progressively ramped up from 0.2 to 0.4, 0.6, 0.8, 1.0, 2.0, and 5.0 ppm, respectively, shown in FIG. 9A. The monotonically reversible sensing result demonstrated a relatively wide detection range for NO₂ to meet the requirements of air quality monitoring and exhaled breath detecting.¹⁰ Exposing the gas sensor to NO₂ of 1 ppm for five consecutive cycles also indicated excellent repeatability, with a relatively stable response of 5‰ and fast response/recovery processes of 360 s/720 s, shown in FIG. 9B. Additionally, the stable response of 5‰ was observed regardless of the incomplete recovery, indicating the full recovery is not necessarily needed for the envisioned applications of long-term monitoring of low-level exposures.

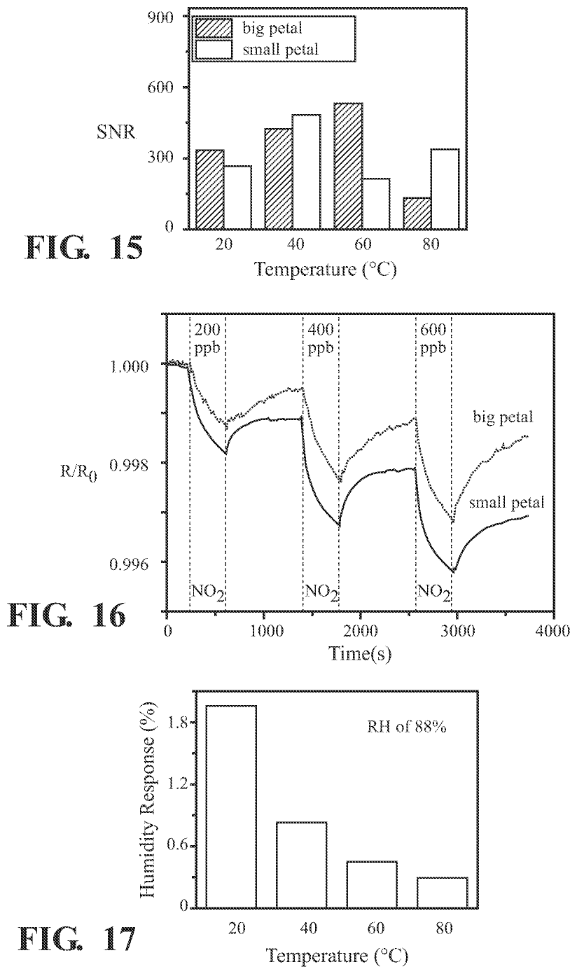

In addition to the response and response/recovery processes, the signal-to-noise ratio (SNR) is another critical parameter in the performance assessment of gas sensors, especially relevant to the calculation of the limit of detection (LOD). In spite of the relatively small responses of a few ‰, the SNR of the rGO/MoS₂-LIG with the small (or big) petal structure to 1 ppm NO₂ gas was 269/482/213/339 (or 331/421/530/132) at 20/40/60/80° C., shown in FIG. 15. The highly porous LIG and the rGO/MoS₂ nanoflowers with a high specific area resulted in low contact resistance, thereby leading to low noise and high SNR.

One parameter to represent the level of noise is its standard deviation RMSₙₒᵢₛₑ in the baseline of the response curve. Calculating the RMSₙₒᵢₛₑ value from 100 data points in the response curves in FIG. 16 of the rGO/MoS₂-LIG sensor with the small (or big) petal structure to NO₂ in the concentration range from 200 ppb to 600 ppb yielded 0.0030‰ (or 0.0036‰). The slope of the simple linear fit in the linear calibration curves (i.e., between the response and NO₂ concentration) was obtained to be 7.49‰/ppm (or 5.42‰/ppm) for the one with the small (or big) petal structure, shown in FIG. 9C. Defining the LOD as 3×RMSₙₒᵢₛₑ/slope, the theoretical estimation of the LOD could be extrapolated from the above linear calibration curves and calculated to be 1.2 ppb (or 2.0 ppb) for the sensor with the small (or big) petal structure. In the validation experiment, an SNR of 62 was still measured with fast response and nearly complete recovery in the sensor with the small petal structure in the presence of 10 ppb NO₂, shown in FIG. 9D. Because the LOD could also be interpreted as the concentration with a signal to be approximately three times of the noise, the measured SNR of 62 in FIG. 9D indicated an actual LOD of less than 1 ppb into the parts per trillion (ppt) range. Though this actual LOD is challenging to be validated with our current static gas testing setup, it will be demonstrated with a more precise testing setup in future studies. The NO₂ gas sensors with an ultralow LOD and self-heating capabilities demonstrated with a simple fabrication method in this study compared favourably to previous studies based on low-dimensional nanomaterials (Table 1).

TABLE 1
Comparison between LIG-based gas sensors and recently published NO₂ gas sensors.

| | | Response/r | | | | | |
|---|---|---|---|---|---|---|---|
| | [symbol] mper | [symbol] overy | LOD | Electrode | | Flexible or | |
| Materials | [symbol] perature | time (s) | (ppd) | fabrication | Heater | stretchable | Reference |
| MoS₂/Graphene | 200 | 21.6/29.4 | 4 | Pt/Ti electrodes | Micro- | No | Long |
| | | (0.5 ppm) | | (deposition) | [symbol] eater | | [symbol] 016³⁰ |
| rGO/MoS₂ | 60 | — | .7 | Au/Ti-IDE | External | No | Zhou |
| | | | | (lithography, | [symbol] eater | | [symbol] 017³¹ |
| | | | | sputter) | | | |
| Single-layer | 200 | 660/720 | 0 | rGO electrodes | External | No | Donarelli |
| MoS₂ | | (1 ppm) | | (spin coat, | [symbol] eater | | [symbol] 015⁷¹ |
| | | | | [symbol] drazine vapor) | | | |
| Single-layer | 250 | 26/480 | 00 | Cr/Au (single | Flexible | Bendable, | Choi |
| graphene | | (40 ppm) | | deposition) | transparent | but not | [symbol] 014²⁶ |
| | | | | | heater | stretchable | |
| Single-layer | RT | 800/1000 | .1 | Au/Gr electrodes | N/A | No | Pham |
| MoS₂ | | (25 ppb) | | [symbol] otolithography, | | | [symbol] 019⁶⁹ |
| | | | | [symbol] tron-beam metal | | | |
| | | | | deposition) | | | |
| MoS₂/SiO₂ | 100 | 1500/2500 | .84 | Pt-IDE | External | No | Shim |
| | | (50 ppm) | | | [symbol] eater | | [symbol] 018⁶⁸ |
| MoS₂—MoO₃ | RT | 15/182 | | Au/Cr (shadow | N/A | No | Kumar |
| microflowers | | (10 ppm) | | [symbol] ask deposition) | | | [symbol] 018⁷⁰ |
| Atomic-layered | RT/100 | 120/1680 | 20 | Au/Cr-IDE | External | No | Cho |
| MoS₂ | | (1.2 ppm) | | (deposition) | [symbol] eater | | [symbol] 015³⁵ |
| 3D MoS₂ | 200 | 33/107 | 8 | Pt/Ti electrodes | Poly- | No | Long |
| aerogel | | (0.5 ppm) | | (deposition) | [symbol] on heater | | [symbol] 017⁷¹ |
| Vertical MoS₂ | RT | — | 00 | Pt/Ti electrodes | N/A | No | Kumar |
| | | | | (deposition) | | | [symbol] 018⁷² |
| Mixed MoS₂ | 125 | 4.4/19.6 | | — | — | No | Agrawal |
| flakes | | (10 ppm) | | | | | [symbol] 018⁷³ |
| MoS₂/SnO₂ | RT | 408/162 | 00 | Au (deposition) | N/A | No | Cui |
| | | (0.5 ppm) | | | | | [symbol] 015⁷⁴ |
| SnS₂ | 120 | 170/140 | 0-30 | Pt- IDE | External | No | Ou 2015⁹ |
| | | (5 ppm) | | [symbol] rodes | [symbol] eater | | |
| | | | | (deposition) | | | |
| Black | RT | 5/not | 00 | Au (deposition) | N/A | No | Cho |
| phosphorus | | [symbol] over | | | | | [symbol] 016⁷⁵ |
| (BP) | | (100 ppm) | | | | | |
| Ag—WS₂ | 100 | 300/600 | | Au/Cr electrodes | — | No | Ko 2016⁷⁶ |
| | | (25 ppm) | | (deposition) | | | |
| MoSe₂ | RT | 250/150 | 0 | Au electrodes | NA | Stretchable | Guo |
| nanosheets | | (1 ppm) | | (deposition) | | | [symbol] 019⁸⁰ |
| Reduced | 150 | 28/— | 000 | Au/Cr -IDE | External | No | Bhati |
| [symbol] raphene/ZnO | | (100 ppm) | | [symbol] odes (shadow | [symbol] eater | | [symbol] 018⁷⁷ |
| | | | | mask deposition) | | | |
| Graphene | RT | — | 50 | Pt/Ti-IDE | N/A | No | Choi |
| | | | | (photolithography, | | | [symbol] 015⁷⁸ |
| | | | | deposition) | | | |
| rGO/MoS₂—G, | 60 | 360/720 | .2 (or | LIG electrodes | Self- | Stretchable | This |
| small (or big) | | (1 ppm) | 2.0) | [symbol] r scribing + | [symbol] eating | (tensile | work |
| petal | | | | metal coating) | | strain of | |
| | | | | | | 20%) | |

[symbol]

indicates data missing or illegible when filed

The selectivity of the rGO/MoS₂-LIG sensor to NO₂ was confirmed in comparison to the responses to a wide range of other interfering gas species that include acetone, ethanol, methanol, ammonia, SO₂, CO, and NO, shown in FIG. 9E. While the sensor response to NO₂ of 1 ppm was 5.1‰, its response was only −0.34‰ to ammonia (NH₃) of 1 ppm, 2.0/−0.19/−0.11‰ to NO/SO₂/CO of 1 ppm, and −0.3/−0.19/−0.5‰ to acetone/ethanol/methanol (CH₃COCH₃/C₂H₅OH/CH₃OH) of 100 ppm. Though the concentration of the volatile organic compounds (VOCs) was much higher than that of NO₂, the sensor response was still much smaller because of their weak interaction with the gas sensing nanomaterials. The sensor responses to NH₃/SO₂/CO of 1 ppm were small yet considerable, but they were in the opposite direction because of their reducing characteristics. In addition to the common interfering gas species such as NH₃, NO, CO, SO₂, and VOCs in the target application environment, humidity often poses significant concern on the gas sensors, especially for those operating at room or low temperatures. Exposing the gas sensor at a high level of relative humidity (RH) demonstrated the humidity effect. After being exposed to an RH of 88% for 6 min, the humidity response was considerable at 20° C. (i.e., 1.96‰). However, the response was significantly reduced at elevated temperatures (i.e., 0.83/0.45/0.29‰ at 40/60/80° C.), as shown in FIG. 17, indicating a small interfering effect of RH on NO₂ response at elevated temperatures. Coating metal-organic framework (MOF) such as a layer of hydrophobic and catalytic Zeolitic Imidazolate Framework-CoZn (ZIF-CoZn, isostructural with ZIF-8(Zn) or ZIF-67(Co)) thin film on the gas sensor could also drastically improve the sensor performance under humidity interference. Additionally, the concept from the electronic nose could be applied to deconvolute the gas response in the presence of humidity based on the measurements from two sensors with one subject to both gas and humidity and the other one subject to humidity alone.

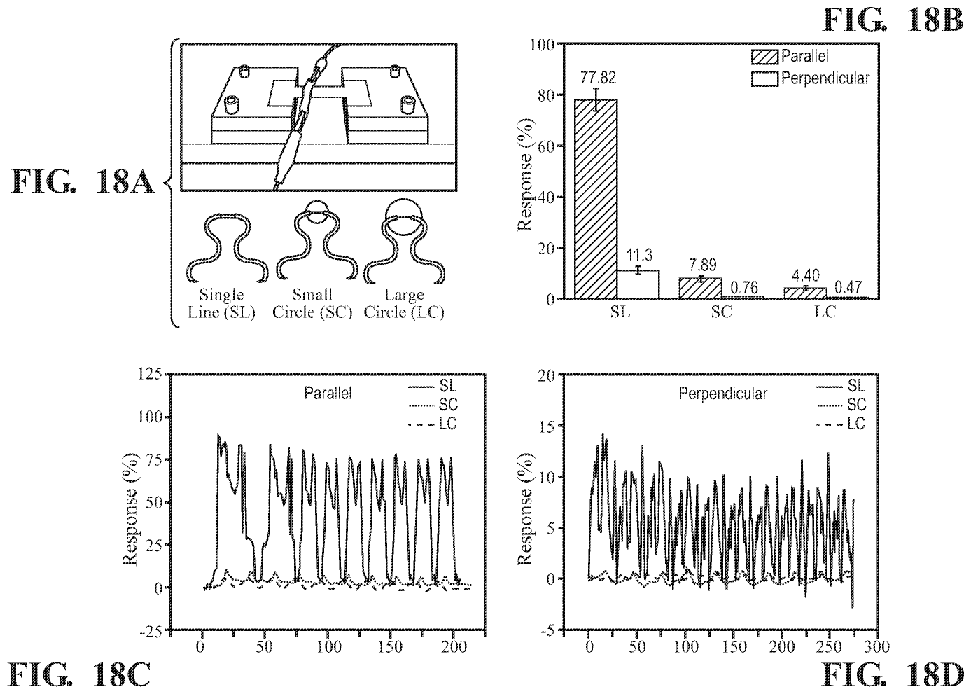

When used in epidermal applications, the LIG gas sensing platform also expects to be mechanically robust with minimum resistance change upon mechanical perturbations such as natural skin motions. As stretchable structures have been extensively studied and explored to ensure stretchable properties in the epidermal devices, they will be exploited to yield a stretchable LIG gas sensing platform. Leveraging the simple laser scribing process, the stretchable serpentine interconnect region can be created during the sensor fabrication in a single step. Because of the serpentine interconnect region, the rGO/MoS₂-LIG gas sensor on an elastomeric substrate such as Ecoflex exhibited a robust mechanical property, shown in FIG. 9F, to withstand a uniaxial tensile strain E of 20% that is comparable to the level of the maximum deformation on the skin surface. The mechano-chemiresistive properties of the rGO/MoS₂-LIG gas sensor with the small petal structure to NO₂ of 1 ppm were investigated. The static tensile strain was applied from a custom-built stretcher with a step motor controlled by Arduino Uno, and the gas sensor was evaluated at both room temperature and 40° C. from self-heating. In addition to maintaining its mechanical integrity, the sensor subject to a uniaxial tensile strain of 20% demonstrated an increased response and faster recovery when compared to the un-stretched (i.e., E=0%) at both room temperature and 40° C. As the tensile strain was increased from 0% to 20%, the sensor response increased from 5.5‰ to 6.2‰ (or from 2.8‰ to 4.0‰) at 20° C. (or 40° C.). The increased response and faster recovery upon mechanical deformation could be attributed to the deformation-induced structure change in the highly porous LIG and the strain engineering of the semiconducting nanomaterials. As a simple and straightforward strategy, strain isolation with a stiff material in the sensing region was explored to demonstrate ways to reduce the strain interfering. FIGS. 18A-18D show stretchability of LIG gas sensor with different designs. A tensile strain of 20% was applied from a custom-built stretcher on the LIG gas sensing platform with three different strain isolation designs, as shown in FIG. 18A. As the existing PI beneath the LIG has Young's modulus much larger than that of the elastomeric substrate, it naturally served as the stiff material for strain isolation. Because of the enhanced stiffness in the device region and the placement of the LIG sensor away from the strain concentration edge, the strain in the LIG sensor is significantly reduced when compared to the applied strain. Progressively increasing the size of the PI pattern (i.e., single line, small circle, and large circle) enhanced the strain isolation effect by moving the LIG gas sensor away from the strain concentration edge. As a result, the resistance change in the LIG gas sensing platform reduced from 11.3‰ for the single line design to 0.47‰ for the large circle design, when a strain of 20% was applied perpendicular to the sensing region. The resistance fluctuation was also greatly suppressed for the large circle design compared with the other two designs, shown in FIGS. 18A-18D. While the LIG gas sensing platform could be attached to the skin surface with its sensing line perpendicular to the major deformation direction, the strain along the parallel direction of the sensing line may not be ignored. In the LIG gas sensing array, the spacing between two sensors could actually follow most of the strain applied to the array with different strain isolation designs. When a strain of 20% parallel to the LIG sensing line was applied, the resistance change in the LIG gas sensing platform reduced from 77.8‰ for the single line design to 4.4‰ for the large circle design. Replacing the spacing with a much compliant material would certainly improve the strain isolation effect to result in a much smaller resistance change. Other than the demonstrated strain isolation strategy, many other stretchable strategies (e.g., pre-strain, self-similar interconnect patterns, and kirigami patterning of the substrate can also be applied to further minimize the strain and reduce the resistance change in the LIG sensing region. While the strain-induced resistance change cannot be ignored for the detection of the ultralow concentration of NO₂, the concept from the electronic nose to deconvolute the gas response in the presence of strain can also be applied here, similar to the proposed strategy to mitigate the humidity effect. The demonstrated stretchable gas sensors could enable the conformal contact to the hierarchically textured skin surface for applications in epidermal electronic devices.

The deconvolution of multiple gaseous components from a mixture requires the use of a high-density gas sensor array with each of the different selectivity. As the first step to demonstrate such a capability of the LIG gas sensing platform, we will demonstrate the application of the LIG gas sensing platform goes from characterization of low-dimensional nanomaterials to a different class of nanomaterials such as heterostructure metal oxides.

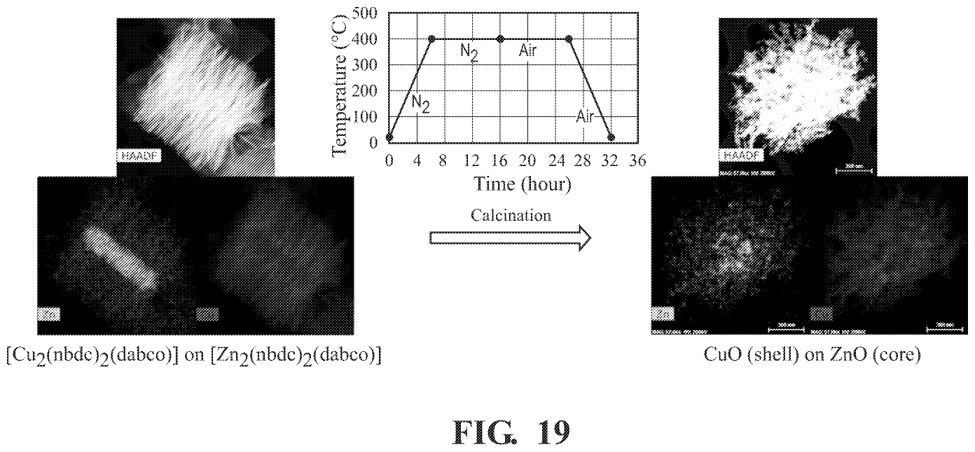

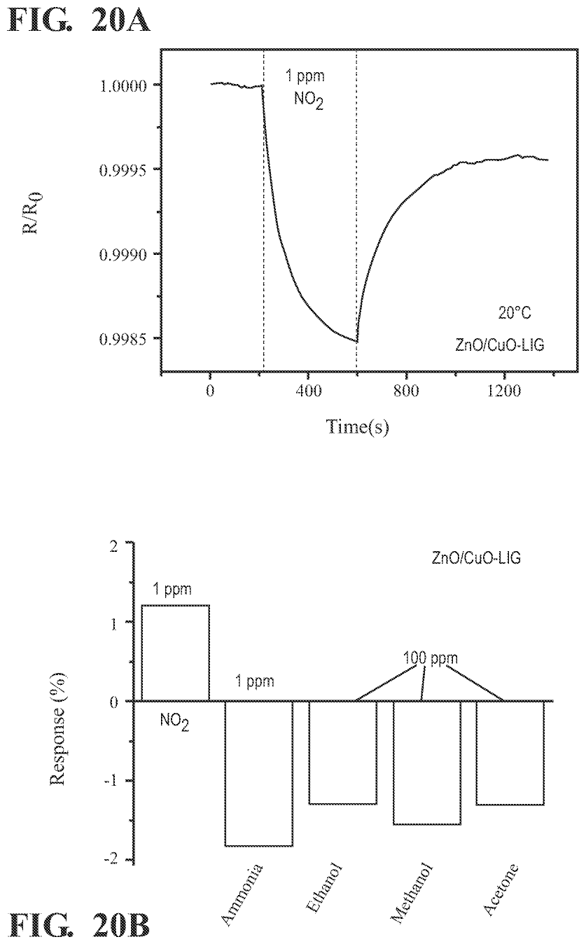

FIG. 19 is a STEM image (HAADF) of Cu₂(nbdc)₂(dabco)-on-Zn₂(nbdc)₂(dabco) metal-organic framework (MOF) with accompanying EDS spectrum images to show the elemental distribution. After calcination, the MOFs formed CuO-on-ZnO nanoparticles, where CuO shell was visible on ZnO core from the EDS spectrum images.

As a representative heterostructure metal oxide, ZnO/CuO core/shell nanomaterials were first prepared by calcination of a Cu—Zn bimetallic metal-oxide framework (MOF), as shown in FIG. 19. Dispersing the ZnO/CuO core/shell nanomaterials in the LIG sensing regions (power of 16%, speed of 10% in the laser scribing process) in a different sensing unit in the array yielded a gas sensor with a response of 1.5‰ and an SNR 390 of to NO₂ of 1 ppm, as shown in FIG. 20A. In contrast to the sensing unit with rGO/MoS₂ (or MoS₂), the sensing unit with ZnO/CuO core/shell nanomaterials exhibited a different selectivity with significant responses to VOCs, shown in FIG. 20B. Considering the other nanomaterials with a different selectivity to VOCs, an array of sensing units with different selectivity to the gaseous components in the mixture could be prepared.

As will be clear to those of skill in the art, the embodiments of the present invention illustrated and discussed herein may be altered in various ways without departing from the scope or teaching of the present invention. Also, elements and aspects of one embodiment may be combined with elements and aspects of another embodiment. It is the following claims, including all equivalents, which define the scope of the invention.

1. A gas sensing platform for sensing a gas component with a concentration, the gas sensing platform comprising:
a chemoresistive gas sensor including:
a sensing region having two interconnect regions each extending continuously from the sensing region, the sensing region comprised of porous graphene; and
a gas-sensitive nanomaterial dispersed in the sensing region operable to deconvolute the gas component from a gas mixture; and
a substrate supporting the sensor;
wherein the chemoresistive gas sensor has a response to the gas component by changing a sensing resistance R of the gas sensing region as the gas-sensitive nanomaterial binds with the gas component such that the gas component can be detected.

2. The gas sensing platform according to claim 1, wherein the interconnect regions are comprised of porous graphene.

3. The gas sensing platform according to claim 1, wherein the interconnect regions and the sensing region are integral.

4. The gas sensing platform according to claim 1, wherein:
the interconnect regions further comprise a layer of conductive material coating the porous graphene for modulating an interconnect resistance of the interconnect region; and
the conductive material is metal.

5. (canceled)

6. The gas sensing platform according to claim 1, wherein the gas-sensitive nanomaterial is rGO, MoS₂, rGO/MoS₂, or ZnO/CuO core/shell nanomaterials selected for binding to different gas components respectively.

7. The gas sensing platform according to claim 1, wherein the substrate is rigid, flexible or stretchable.

8. The gas sensing platform according to claim 1, wherein the response is characterized by a ratio (R₀−R)/R₀, wherein R₀ is a resistance of the gas sensing region in the presence of only air, wherein the ratio (R₀−R)/R₀ is at least 1/10000.

9. The gas sensing platform according to claim 1, wherein the interconnect regions have an interconnect resistance smaller than the sensing resistance of the sensing region, wherein the gas sensing region generates localized heating upon an externally applied voltage due to a difference between the sensing resistance of the gas sensing region and the interconnect resistance of the interconnect regions.

10. The gas sensing platform according to claim 1, wherein:
the porous graphene is laser-induced graphene; and/or
the sensing region generally forms a straight line.

11. (canceled)

12. The gas sensing platform according to claim 1, wherein:
the interconnect regions are wavy or serpentine or any other nonlinear shape and the substrate is stretchable; and/or
a linewidth of the sensing region is narrower than a width of the interconnect regions.

13. (canceled)

14. The gas sensing platform according to claim 1, wherein the nanomaterial in the sensing region is recoverable.

15. A gas sensing platform array, comprising an array of the gas sensing platforms according to claim 1, wherein each of the gas sensing platforms in the array is tailored to sense a different gas component.

16. A method of making a gas sensing platform for sensing a gas component with a concentration, the method comprising the steps of:
providing a carbon-containing film;
forming porous graphene patterns on the film using a laser system, the pattern including a sensing region disposed between two interconnect regions each extending continuously from one end of the sensing region;
disposing the pattern onto a substrate;
coating a layer of conductive material onto the interconnect regions; and
depositing gas-sensitive nanomaterials in the sensing region for binding to the gas component.

17. The method according to claim 16, wherein the carbon-containing film is polyimide (PI).

18. The method according to claim 16, wherein the step of transferring comprises cutting the pattern off the film using the laser system.

19. The method according to claim 18, wherein an area around the sensing region is cut off together with the sensing region for reducing strain interference.

21. The method according to claim 16, further comprising tuning an interconnect resistance of the interconnect region by changing a length-to-width ratio of the interconnect region and tuning a sensing resistance of the sensing region by changing a length-to-width ratio of the sensing region.

22. A method of using a gas sensing platform of claim 1 for sensing a gas component with a concentration, the method comprising the steps of:
providing a gas sensing platform of claim 1;
measuring a first resistance of the gas sensing platform in air upon an externally applied voltage;
exposing the gas sensing platform to a gas mixture;
measuring a second resistance of the gas sensing platform upon an externally applied voltage with the exposure to the gas mixture; and
determining a component of the gas mixture and concentration of the gas component based on the type of the gas-sensitive nanomaterial and the difference between the second and first resistances.

23. The method according to claim 22, wherein:
the gas sensing is carried out in a range of 20-37° C.; and/or
the concentration of the gas to be sensed is smaller than 10 parts per billion.

24. (canceled)
